(19) United States
(12) Patent Application Publication
(10) Pub. No.: US 2015/0077637 A1
(43) Pub. Date: Mar. 19, 2015

(54) DISPLAY DEVICE, DISPLAY DEVICE CONTROL METHOD, TELEVISION RECEIVER, CONTROL PROGRAM, AND RECORDING MEDIUM

(71) Applicant: SHARP KABUSHIKI KAISHA, Osaka-shi, Osaka (JP)

(72) Inventors: Shigeki Taniguchi, Osaka-shi (JP); Akira Koike, Osaka-shi (JP); Mihoko Watanabe, Osaka-shi (JP); Kohichi Takaku, Osaka-shi (JP); Kohichi Hirata, Osaka-shi (JP); Tsuyoshi Ohmori, Osaka-shi (JP)

(73) Assignee: SHARP KABUSHIKI KAISHA, Osaka-shi, Osaka (JP)

(21) Appl. No.: 14/396,328

(22) PCT Filed: Mar. 27, 2013
(86) PCT No.: PCT/JP2013/059081

§ 371 Date: Oct. 22, 2014

(30) Foreign Application Priority Data
May 16, 2012 (JP) 2012-112794
Mar. 26, 2013 (JP) 2013-065212

(51) Int. Cl. H04N 5/57

(52) U.S. Cl. CPC H04N 5/57
USPC 348/687

(57) ABSTRACT

The display device (1) which displays a video on a display section (7) includes a video processing circuit (2) and a backlight control circuit (3) for aperiodically changing at least any of a brightness and a contrast of the video, which is displayed on the display section (7), within a predetermined range during a predetermined time period.

### TECHNICAL FIELD

The present invention relates to a display device for displaying a video, a method for controlling the display device, a television receiver, a control program, and a storage medium.

### BACKGROUND ART

A resolution of a television has been heightened, and a high-definition television and a full-high-definition television have become popular. Under the circumstances, a BD (Blu-ray Disc) of an old movie is sold which has been remastered by a distributor such as a movie company, and therefore a user can generally enjoy a high image quality video of the old movie.

Meanwhile, the old movie is remastered to have high image quality, i.e., to be a bright and sharp video, and this causes the user feels like the user is watching a television drama. Accordingly, the user cannot feel as if the user is watching the old movie at an old movie theater.

Under the circumstances, a technique has been developed to reproduce an old movie having high image quality such that a user can feel as if the user is watching the old movie at an old movie theater. For example, Patent Literature 1 discloses a technique in which a backlight is controlled to flicker so as to provide an effect of a shutter-type old projector used at a movie theater. Moreover, Patent Literature 2 discloses a technique in which a high-frequency accentuation image and a low-frequency image are prepared from an inputted image and the images are alternately read out and displayed so as to reproduce, on an electronic display, a flicker feeling and a double image with a doubled frequency (48 Hz), which were expressed at a conventional movie theater.

### CITATION LIST

### Patent Literature

[Patent Literature 1]
Japanese Patent Application Publication Tokukai No. 2012-8515 (Publication date: Jan. 12, 2012)
[Patent Literature 2]
Japanese Patent Application Publication Tokukai No. 2011-17936 (Publication date: Jan. 27, 2011)

### SUMMARY OF INVENTION

### Technical Problem

At an old movie theater, a movie was shown with an old projector. At the old movie theater, a voltage was not stable which was applied to a halogen lamp or a carbon arc (hereinafter, simply referred to as “lamp”) used in such an old projector. Therefore, light emitted by the lamp became unstable, i.e., became bright and dark (hereinafter, referred to as “lamp fluctuation”).

However, according to the conventional configurations, the lamp fluctuation is not reproduced, and there is a room for improvement in reproducibility of the atmosphere of watching an old movie as if at an old movie theater.

The present invention is accomplished in view of the problem, and its main object is to provide a display device that can reproduce an atmosphere of watching an old movie at an old movie theater.

### Solution to Problem

In order to attain the object, a display device of the present invention includes: a display section for displaying a video; and control means for aperiodically changing at least any of a brightness and a contrast of the video, which is displayed on the display section, within a predetermined range during a predetermined time period.

In order to attain the object, a method of the present invention is a method for controlling a display device having a display section for displaying a video, the method including the step of: aperiodically changing at least any of a brightness and a contrast of the video, which is displayed on the display section, within a predetermined range during a predetermined time period.

### Advantageous Effects of Invention

The display device of the present invention includes: a display section for displaying a video; and control means for aperiodically changing at least any of a brightness and a contrast of the video, which is displayed on the display section, within a predetermined range during a predetermined time period.

According to the configuration, the display device brings about an effect of reproducing an atmosphere of watching an old movie in an old movie theater.

### BRIEF DESCRIPTION OF DRAWINGS

FIG. 1 is a block diagram illustrating an example configuration of main parts of a display device in accordance with an embodiment of the present invention.

FIG. 2 is a view illustrating variation in brightness of a backlight over time.

FIG. 3 is a view illustrating an example of a random number table used to control a brightness of a backlight.

FIG. 4 is a flowchart indicating an example flow of controlling a backlight by a backlight control circuit.

FIG. 5 is a view illustrating an example of an average table which is used to control a brightness of the backlight and has been prepared with the use of the random number table of FIG. 3.

FIG. 6 is a view illustrating an example of a table that shows a range of variation in values of screen brightness which are set by a user for each screen size.

### DESCRIPTION OF EMBODIMENTS

### Embodiment 1

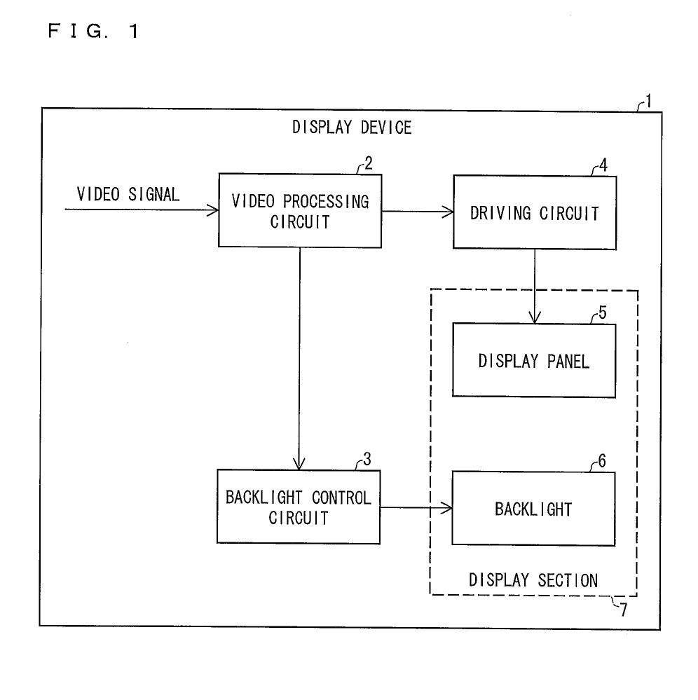

The following description will discuss an embodiment of the present invention with reference to FIGS. 1 through 6.

[Configuration of Display Device]

The following description will discuss a display device of the present invention with reference to FIG. 1. The display device of the present invention is a device for displaying an image, and is, for example, a digital television, a PC monitor, a mobile phone, a PDA (Personal Digital Assistant), a game machine, an electronic blackboard, a digital camera, or a video camera. Note that a television receiver including a display device is also encompassed in the scope of the invention described in this specification.

The display device of the present embodiment has, as an image quality adjusting mode, a movie (classic) mode in addition to image quality adjusting modes such as a game mode and a normal movie mode. The movie (classic) mode is an image quality adjusting mode in which a video of a vintage movie is displayed while being adjusted to have an image quality (predetermined image quality) with which unique fineness, noise, flicker, and the like as above described are reproduced as much as possible.

FIG. 1 is a block diagram illustrating an example configuration of main parts of a display device 1. As illustrated in FIG. 1, the display device 1 includes a video processing circuit (control means, contrast control means, random number table managing means) 2, a backlight control circuit (control means, backlight control means) 3, a driving circuit 4, a display panel 5, and a backlight 6. Note that the display device 1 can include members such as a communication section and an antenna, etc. for obtaining (receiving) a video signal from the outside, a storage section for retaining the video signal, a decoding section for decoding the video signal and a tuner, etc., an operation section, an audio inputting section, and an audio outputting section, etc. Note, however, that these members do not relate to the characteristic feature of the invention, and are therefore not illustrated in the drawings.

The video processing circuit 2 adjusts image quality of an obtained video and carries out scaling with respect to the obtained video. Here, the phrase “adjusts image quality” indicates, for example, changing a contrast of the obtained video by correcting pixel values of the obtained video. The video processing circuit 2 can change at least any of luminance and sharpness for adjusting image quality. The term “scaling” indicates reducing a size while maintaining an original aspect ratio of a video to be displayed. The video processing circuit 2 outputs the video signal, which has been subjected to the image quality adjustment and the scaling, to the driving circuit 4.

The backlight control circuit 3 controls, for example, a timing at which the backlight 6 emits light, a time period during which the backlight 6 emits light (and a time period during which the backlight 6 does not emit light), and an intensity (brightness) of light emitted by the backlight 6. Details of the backlight control circuit 3 will be described later.

The driving circuit 4 receives a video signal from the video processing circuit 2, and controls, based on the video signal thus received, an amount of light which passes through each of pixels of the display panel 5.

The display panel 5 has pixels of, for example, R, G, and B, and displays a video by causing light, which has been emitted by the backlight 6, to pass through the pixels. The display panel is, for example, a liquid crystal panel.

The backlight 6 is a direct LED backlight which emits light toward the display panel 5. Note, however, that the backlight 6 is not limited to this, and the backlight 6 can be an edge light type. Alternatively, another light source such as a cold cathode fluorescent tube can be employed.

According to the present embodiment, the display panel 5 and the backlight 6 are correctively referred to as “display section 7” (see FIG. 1). In other words, the display section 7 is a part for displaying a video. Note that the display section 7 may include the backlight control circuit 3 or the driving circuit 4, or the backlight control circuit 3 and the driving circuit 4, in addition to the display panel 5 and the backlight 6.

(Control by Backlight Control Circuit 3)

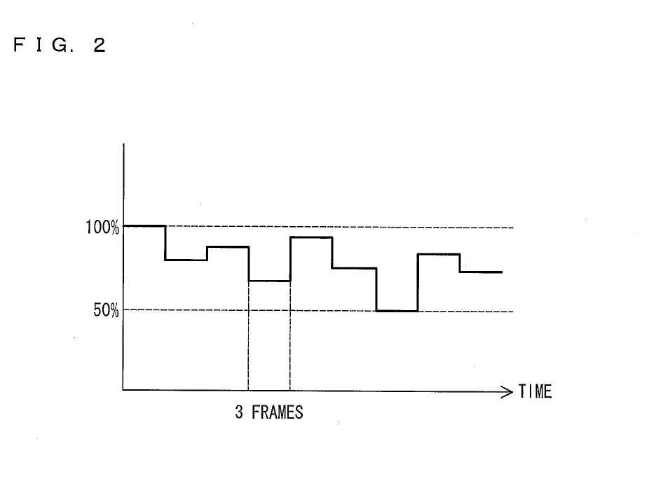

The following description will discuss concrete examples of controlling (changing) luminance (brightness) of the backlight 6 by the backlight control circuit 3, with reference to FIGS. 2 through 5.

### Concrete Example 1

The following description will first discuss Concrete Example 1 of control carried out by the backlight control circuit 3, with reference to FIG. 2. FIG. 2 is a view illustrating variation in brightness of the backlight 6 over time. In FIG. 2, the horizontal axis indicates time, and the vertical axis indicates brightness. According to the present embodiment, a normal brightness is set as 100%. Hereinafter, a set brightness of the backlight 6 is referred to as “backlight setting value”.

As illustrated in FIG. 2, the backlight control circuit 3 aperiodically (randomly) changes a brightness of the backlight 6 within a predetermined range every predetermined frame(s), with the use of random numbers managed by the display device 1 in advance. In FIG. 2, the brightness of the backlight 6 is changed every 3 frames. Note, however, that the present invention is not limited to this.

Note that the random numbers can be generated by the video processing circuit 2 or can be obtained from an external apparatus.

According to the present embodiment, a range (predetermined range) of variation in brightness of the backlight 6 is set to a range between 50% and 100% (i.e., a difference (variation range) between an upper limit value and a lower limit value is 50%). Note, however, that the predetermined range is not limited to this. In a case where a size of the display panel 5 of the display device is large and the brightness of the backlight 6 is greatly changed, some users may feel ill. Under the circumstances, the range in which the brightness of the backlight 6 is changed can be determined depending on the size of the display panel 5 of the display device 1.

For example, in a case where the size of the display panel 5 is 60 inches or smaller, the predetermined range can be between 50 and 100(%) (i.e., variation range of 50%); in a case where the size of the display panel 5 is 70 inches, the predetermined range can be between 60 and 100(%) (i.e., variation range of 40%); in a case where the size of the display panel 5 is 80 inches, the predetermined range can be between 70 and 100(%) (i.e., variation range of 30%); and in a case where the size of the display panel 5 is 90 inches, the predetermined range can be between 80 and 100(%) (i.e., variation range of 20%). Note that the predetermined ranges relative to the size of the display panel 5 are merely examples, and the predetermined range is not limited to these.

Note that the random numbers are numerical values falling within the range (predetermined range) of variation in brightness of the backlight 6. According to the present embodiment, the predetermined range is between 50 and 100, and accordingly the random numbers are numerical values within the range between 50 and 100.

The backlight control circuit 3 calculates a backlight setting value by subtracting, as an offset, the random number from a normal backlight setting value of the backlight 6. Note that the backlight control circuit 3 can calculate a backlight setting value by multiplying the normal backlight setting value of the backlight 6 by the random number as a gain value. In the movie (classic) mode, by thus changing the backlight setting value so as to reduce the normal brightness of the backlight 6, it is possible to prevent an abnormal load from being applied to the backlight 6.

As such, the backlight control circuit 3 aperiodically changes, within the predetermined range, a brightness of a video displayed on the display panel 5 (i.e., the brightness of the backlight 6) with the use of the random numbers. This allows the display device 1 to reproduce aperiodic lamp fluctuation which is similar to that of an actual projector.

### Concrete Example 2

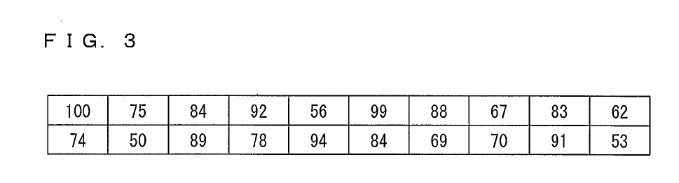

The following description will discuss Concrete Example 2 of control carried out by the backlight control circuit 3, with reference to FIG. 3. In Concrete Example 2, the video processing circuit 2 manages random numbers in a table (random number table), and the backlight control circuit 3 calculates a backlight setting value with the use of a random number obtained from the table (random number table). FIG. 3 is a view illustrating an example of a random number table used when the backlight control circuit 3 controls the brightness of the backlight 6.

The video processing circuit 2 manages random numbers as the random number table as illustrated in FIG. 3. The video processing circuit 2 manages the random number table in which numerals are sequenced like 100, 75, 84, 92, and so forth from the upper left to the right (see FIG. 3). Note that the random numbers are numerical values falling within the range (predetermined range) of variation in brightness of the backlight 6, as with Concrete Example 1.

The backlight control circuit 3 sequentially obtains random numbers (factors) in the random number table from the upper left to the right. Then, the backlight control circuit 3 calculates each backlight setting value by (i) subtracting, as an offset, each of the obtained random numbers from the normal backlight setting value of the backlight 6 or (ii) multiplying the normal backlight setting value of the backlight 6 by each of the obtained random numbers as a gain value.

In a case where the number of random numbers (i.e., the number of factors) included in the random number table is small, similar lamp fluctuations are periodically caused at regular intervals. For example, in a case where (i) the display device 1 is configured to display a video at 60 frames per second, (ii) the number of factors is 300, and (iii) the backlight setting value is set to be changed every 3 frames, a time period (predetermined time period) for making a circuit of the random number table is (1/60)×3×300=15 seconds. Therefore, in order to increase the time period for making a circuit of the random number table, the random number table is enlarged.

Note that the random number table can be (i) a random number table which is managed by the display device 1 in advance, (ii) a random number table generated by the video processing circuit 2, or (iii) a random number table obtained from an external apparatus.

The random number table can be updated every predetermined time period. The update of the random number table can be carried out by using (i) random numbers which are generated again by the video processing circuit 2 or (ii) a random number table supplied from an external apparatus such as a PC. Alternatively, it is possible that a plurality of random number tables are stored in a memory of the display device 1 in advance, and the random number table is updated by selecting, with the use of random numbers generated by the video processing circuit 2, a random number table to be used out of the plurality of random number tables stored in the memory. This allows the backlight setting value to be gently changed like a sine curve or to be acutely changed.

As such, the display device 1 can aperiodically change the brightness of the backlight 6 within the predetermined range during the predetermined time period, with reference to the random number table. This makes it possible, more properly, to reproduce aperiodic lamp fluctuation which is similar to that of an actual projector.

### Concrete Example 3

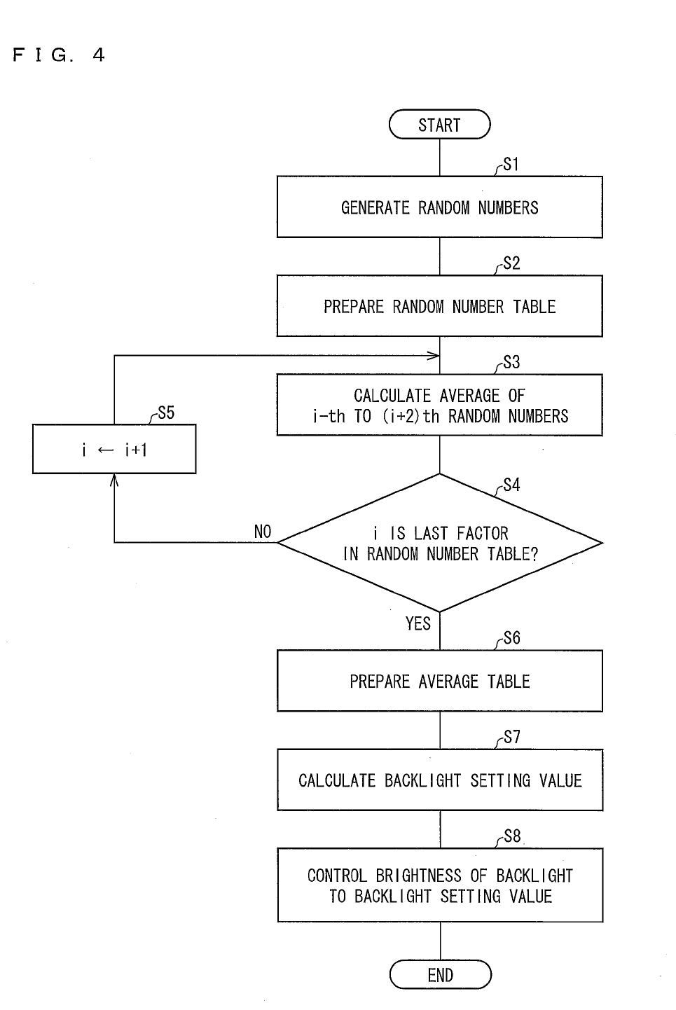

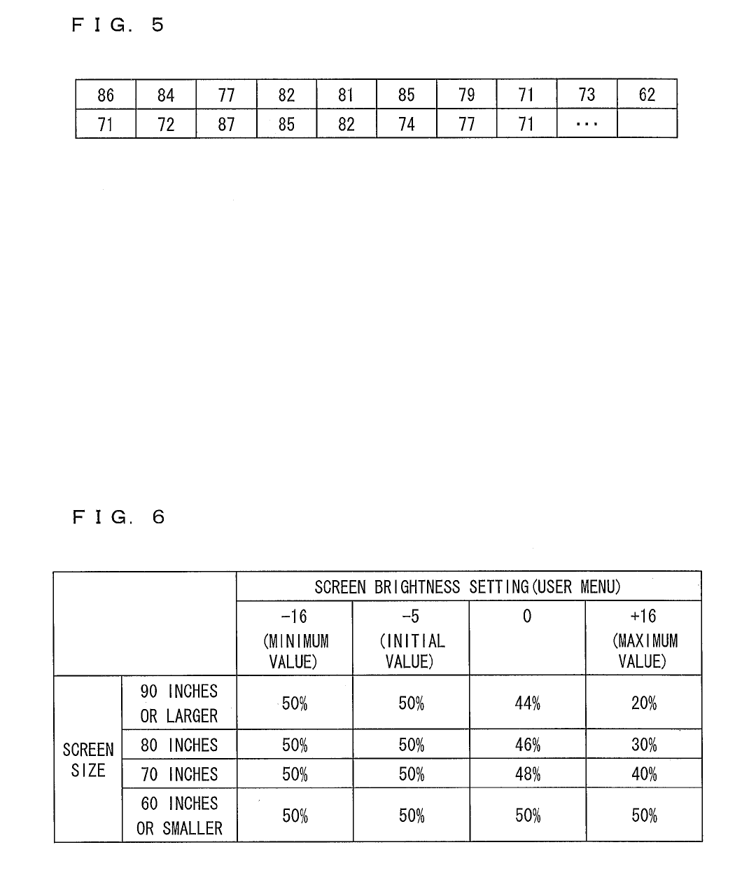

The following description will discuss Concrete Example 3 of control carried out by the backlight control circuit 3, with reference to FIGS. 4 and 5. It is possible to reproduce aperiodic lamp fluctuation, which is similar to that of an actual projector, by the use of random numbers or a random number table for managing random numbers, which are described in Concrete Example 1 and Concrete Example 2. However, an excessively bright state or an excessively dark state may continue for a long time. This may cause behavior like malfunction.

In view of this, the video processing circuit 2 does not manage random numbers as they are in the table but (i) prepares, with the use of the random numbers, a table (hereinafter, referred to as “average table”) with which the backlight setting value changes more gently and (ii) manages such a table.

FIG. 4 is a flowchart indicating an example flow of controlling the backlight 6 by the backlight control circuit 3. FIG. 5 is a view illustrating an example of an average table which is used to control the brightness of the backlight 6 by the backlight control circuit 3 and has been prepared with the use of the random number table of FIG. 3.

As illustrated in FIG. 4, the video processing circuit 2 first generates random numbers (step S1, hereinafter simply referred to as “S1”). The video processing circuit 2 then prepares a random number table from the random numbers thus generated (S2). Note that, instead of employing the configuration in which the video processing circuit 2 generates the random numbers, (i) a random number table can be prepared with the use of a random number table manage by the display device 1 in advance or (ii) a random number table can be supplied from an external apparatus.

Next, the video processing circuit 2 calculates a moving average of the random numbers included in the random number table. Specifically, the video processing circuit 2 calculates an average of i-th to (i+2)th random numbers in the random number table (S3). Then, the video processing circuit 2 confirms whether or not a first factor (i.e., the i-th factor) used to calculate the moving average is a last factor of the random number table (S4). In a case where the first factor is not the last factor (NO in S4), the video processing circuit 2 increments the numeral “i” (S5), and carries out the process of the step S3. In a case where the i-th factor used to calculate the moving average is the last factor of the random number table (YES in S4), that is, all moving averages have been calculated, the video processing circuit 2 prepares a table (average table) of all the moving averages (S6).

The following description will further discuss the steps S3 through S6 with reference to FIGS. 3 and 5. The video processing circuit 2 first calculates an average of first through third random numbers in the random number table. In a case where the random number table illustrated in FIG. 3 is used, the calculation is carried out as follows: i.e., (100+75+84)/3=86. Next, an average of first through third random numbers in the random number table is calculated as follows: i.e., (75+84+92)/3=84. In this manner, the video processing circuit 2 calculates each moving average of random numbers in the random number table. Then, the video processing circuit 2 prepares an average table as illustrated in FIG. 5 with the use of the moving averages thus calculated.

Subsequently, the backlight control circuit 3 calculates a backlight setting value by (i) subtracting, as an offset, each of the moving averages included in the average table from the normal backlight setting value of the backlight 6 or (ii) multiplying the normal backlight setting value of the backlight 6 by each of the moving averages as a gain value (S7).

Then, the backlight control circuit 3 controls the brightness of the backlight 6 to the backlight setting value thus calculated (S8).

The present embodiment has been exemplified by the configuration in which the number of factors (i.e., window length) of which the moving average is obtained is 3. Note, however, that the present invention is not limited to this, and the moving average can be an average of an arbitrary number of factors.

The present embodiment has been exemplified by the configuration in which a moved distance (shift length) of the moving average is 1. Note, however, that the present invention is not limited to this, and an arbitrary moved distance can be employed.

Moreover, the present embodiment has been exemplified by the configuration in which the backlight setting value is changed every 3 frames. Note, however, that the number of frames is not limited to this, and can be an arbitrary number of frames. For example, in a case where the backlight setting value is changed every 6 frames, it is possible to change the brightness of the backlight 6 slowly, as compared with the case in which the backlight setting value is changed every 3 frames.

As such, the display device 1 of the present invention can aperiodically change the brightness of the backlight 6 within the predetermined range during the predetermined time period, with reference to the moving averages of the random numbers included in the random number table. This allows the display device 1, more gently, to reproduce aperiodic lamp fluctuation which is similar to that of an actual projector.

(Function of Lamp Fluctuation Effect in Movie (Classic) Mode)

The display device 1 is configured to cause the display panel 5 to display a user interface (UI) via which a user can set a range in which the backlight control circuit 3 changes the brightness of the backlight 6 in the movie (classic) mode. The following description will discuss the user interface.

The display panel 5 displays a menu screen on which the user can select a “lamp fluctuation effect” for setting a range of variation in brightness of the backlight 6. On a screen for setting the lamp fluctuation effect, for example, numerical values of 0 through 3 are displayed.

Here, for example, it is assumed that the predetermined range which can be set is a range between 50% and 100% (i.e., the variation range is 50%). In this case, the numerical value 0 on the setting screen indicates that the lamp fluctuation effect is not active, the variation range is 0%, and the backlight setting value is constantly 100%. Similarly, the numerical value 1 on the setting screen indicates that the lamp fluctuation effect is weak, the variation range is 10%, and the backlight setting value is (100−(100−random number)×(1/5)); the numerical value 2 on the setting screen indicates that the lamp fluctuation effect is moderate, the variation range is 30%, and the backlight setting value is (100−(100−random number)×(3/5)); and the numerical value 3 on the setting screen indicates that the lamp fluctuation effect is strong, the variation range is 50%, and the backlight setting value is a value of a random number. Note that the method for calculating the backlight setting value is not limited to this, and it is possible to use a calculation formula which is suitable for a location in which the display device 1 is placed or for a size of the screen.

By thus allowing the user to set the lamp fluctuation effect, it is possible to provide an optimal operation in accordance with the user's preference.

### Concrete Example 4

The display device 1 of the present embodiment reproduces an atmosphere of an old projector in which a carbon arc lamp or the like is used. However, the display device 1 of the present embodiment sometimes displays a high-contrast video, unlike a screen of a movie theater. Under the circumstances, the user sometimes feels more strongly a change in brightness of the screen, depending on the size of the display panel 5.

Specifically, in a movie theater, the user watches a video which is displayed by reflecting, on a screen, light which has been emitted by a projector, and therefore the user feels a gentle change in luminance. On the other hand, a television emits light by itself, and therefore a contrast of a video displayed by the television is high. Further, in a case where the user sets the display device 1 to display with a high brightness (i.e., the brightness of the backlight 6), the user feels sharp fluctuation in brightness of the screen. The above described lamp fluctuation effect is a function to reproduce unique light emission caused due to unstable discharging path of carbon arc discharge employed in an old projector. However, such a change in luminance within a high luminance range cannot actually occur in an old projector. Therefore, the user enjoying an atmosphere of the old projector may feel unnaturalness on such a sharp fluctuation in brightness caused due to the change in luminance within the high luminance range.

The user feels fluctuation in brightness of the screen more strongly as the screen size (i.e., the size of the display panel 5) becomes larger. Under the circumstances, in order to reduce unnaturalness due to fluctuation, the range of variation in brightness of the backlight 6 can be determined based on a combination of a setting of the brightness of the backlight and a size of the display panel 5 of the display device 1.

FIG. 6 is a view illustrating an example of a table that shows a range of variation in values of screen brightness (i.e., brightness of the backlight 6) which are set by the user for each screen size (i.e., size of the display panel 5).

As shown in FIG. 6, in the table, a variation range of brightness of the backlight 6 is indicated for each combination of a setting value and a screen size. This table shows, for example, that a screen size, to which a range “30%” (which is relatively narrow) is assigned when being combined with a setting value “+16”, is larger than a screen size, to which a range “40%” (which is relatively wide) is assigned when being combined with the setting value “+16”, by 10 inches (=80 inches−70 inches). Moreover, this table shows, for example, that the setting value, to which the range “30%” (which is relatively narrow) is assigned when being combined with the screen size “80 inches”, is larger than the setting value, to which a range “46%” (which is relatively wide) is assigned when being combined with the screen size “80 inches”, by 16 (=16−0).

In FIG. 6, the values for setting the brightness of the backlight 6 fall within the range between −16 and +16. Note, however, that the present invention is not limited to this.

Here, the value for setting the brightness of the backlight 6 is a value set by the user via a setting screen (e.g., user menu) in advance. Note, however, that the value for setting the brightness of the backlight 6 is not limited to this, and can be a value which has been set in the display device 1 in advance.

In a case where, for example, the size of the display panel 5 is 90 inches or larger and the value for setting the brightness of the backlight 6 is −16 as shown in FIG. 6, the backlight control section 3 of the display device 1 can determine, with reference to the table of FIG. 6, a range (predetermined range) of variation in brightness of the backlight 6 such that a difference (variation range) between an upper limit value and a lower limit value of the predetermined range becomes 50%. Moreover, in a case where the size of the display panel 5 is 90 inches or larger, the variation range can be 50% when the value for setting the brightness of the backlight 6 is −5 (in FIG. 6, this is an initial value for setting brightness), the variation range can be 44% when the value for setting the brightness of the backlight 6 is 0, and the variation range can be 20% when the value for setting the brightness of the backlight 6 is +16.

Meanwhile, for example, in a case where the size of the display panel 5 is 60 inches or smaller and the value for setting the brightness of the backlight 6 is any of −16, −5, 0, and +16, the backlight control section 3 can determine, with reference to the table of FIG. 6, the range (predetermined range) of variation in brightness of the backlight 6 such that a difference (variation range) between an upper limit value and a lower limit value of the predetermined range becomes 50%. Note that the range, in which the brightness of the backlight 6 is changed in accordance with a value set by the user for each size of the display panel 5, is merely an example, and is not limited to this.

As such, the display device 1 changes the variation range in accordance with the combination of the brightness setting of the backlight 6 and the size of the display panel 5, and this makes it possible to reduce unnaturalness felt by the user. Specifically, unnaturalness felt by the user can be reduced by changing the variation range such that, (i) in a case where the display panel 5 has a predetermined size or larger, the variation range is narrowed in stages as the value for setting the brightness becomes larger, and (ii) in a case where the value for setting the brightness is the predetermined value (i.e., 0 in the present embodiment, but can be a minimum value) or larger, the variation range becomes narrower as the size of the display panel 5 becomes larger.

In the example, the configuration has been described in which the variation range is determined based on the combination of the brightness setting of the backlight 6 and the size of the display panel 5. Note, however, that the variation range can be determined in accordance with the brightness setting of the backlight 6, regardless of the size of the display panel 5.

Alternatively, the variation range can be changed based on a combination of the brightness setting of the backlight 6 and a size of a video displayed on the display panel 5.

For example, in a case where a video of 90 inches is displayed on the entire display panel 5 of 90 inches, the backlight control section 3 can control the brightness of the backlight as follows.

That is, in a case where the value for setting the brightness of the backlight 6 is −16, the backlight control section 3 of the display device 1 can determine the predetermined range such that a difference (variation range) becomes 50% between an upper limit value and a lower limit value of a range (predetermined range) of variation in brightness of the backlight 6. Moreover, in a case where the value for setting the brightness of the backlight 6 is −5, the variation range can be 50%; in a case where the value for setting the brightness of the backlight 6 is 0, the variation range can be 44%; and in a case where the value for setting the brightness of the backlight 6 is +16, the variation range can be 20%.

Alternatively, for example, in a case where a video of 60 inches is displayed in a center of the display panel 5 of 90 inches and no video is displayed around the video of 60 inches, the backlight control section 3 can control the brightness of the backlight as follows.

That is, in a case where the value for setting the brightness of the backlight 6 is any of −16, −5, 0, and +16, the backlight control section 3 can determine the predetermined range such that a difference (variation range) becomes 50% between an upper limit value and a lower limit value of a range (predetermined range) of variation in brightness of the backlight 6.

As such, the display device 1 changes the variation range in accordance with the combination of the brightness setting of the backlight 6 and the size of the video, and this also makes it possible to reduce unnaturalness felt by the user. Specifically, unnaturalness felt by the user can be reduced by changing the variation range such that, (i) in a case where the video has a predetermined size or larger, the variation range is narrowed in stages as the value for setting the brightness becomes larger, and (ii) in a case where the value for setting the brightness is the predetermined value (i.e., 0 in the present embodiment, but can be a minimum value) or larger, the variation range becomes narrower as the size of the video becomes larger.

### Embodiment 2

The configuration has been described in which the lamp fluctuation is reproduced by changing the brightness of the backlight 6. Note, however, that the present invention is not limited to this. For example, the lamp fluctuation can be reproduced by changing a contrast of a video.

The video processing circuit 2 sets a normal contrast (contrast setting value) to 100% (i.e., by 1.00 time) and, as with Concrete Example 1, aperiodically (randomly) changes the contrast within a predetermined range every predetermined frame(s) by correcting pixel values of the video with the use of random numbers managed by the display device 1 in advance. This allows the display device 1 to reproduce aperiodic lamp fluctuation which is similar to that of an actual projector.

Note that the contrast can be changed, for example, within a range between 0.2 time and 1.2 times on the setting screen of the display device 1. In this example, the contrast can be aperiodically changed, for example, within a range between 0.8 time and 1.2 times.

In a case where the contrast is controlled to be higher than a normal contrast, saturation of a video can occur. That is, a problem can occur in which blown-out white, color missing, and the like occur in a high tone video and therefore an object is seen and lost by lamp fluctuation. In view of this, the video processing circuit 2 preferably controls the contrast to be lower than the normal contrast, as in this example.

Alternatively, the video processing circuit 2 can aperiodically change the contrast within a predetermined range during a predetermined time period with reference to a random number table, as with Concrete Example 2. Alternatively, the video processing circuit 2 can aperiodically change the contrast within a predetermined range during a predetermined time period with reference to moving averages of random numbers included in a random number table, as with Concrete Example 3.

The range (predetermined range) within which the contrast is changed can be determined depending on the size of the display panel 5 of the display device 1.

This allows the display device 1, more properly, to reproduce aperiodic lamp fluctuation which is similar to that of an actual projector.

As with the brightness of the backlight, the contrast can be set with the use of the user interface.

Moreover, the video processing circuit 2 can change a contrast of only a video. That is, in a case where a screen displayed on the display panel 5 includes a data broadcasting content, a menu screen, an Internet screen, and the like in addition to the video, it is possible that the video processing circuit 2 subjects only the video to the lamp fluctuation effect and does not subject the other parts to the lamp fluctuation effect. As such, the display device 1 can give the lamp fluctuation effect only to a region in which a video is displayed.

### Embodiment 3

The backlight control circuit 3 can divide the backlight 6 into a plurality of regions and control, for each of the regions thus divided, a timing at which light is emitted by the backlight 6, a time period during which light is emitted by the backlight 6 (or a time period during which light is not emitted by the backlight 6), an intensity of light emitted by the backlight 6, and the like. The backlight control circuit 3 can carry out a so-called local dimming control.

In this case, the backlight control circuit 3 can change the brightness of the backlight in accordance with a backlight setting value only in a region of the backlight 6 which region corresponds to a region of the display panel 5 in which region a video is displayed.

[Remarks]

The present invention is not limited to the embodiments, but can be altered by a skilled person in the art within the scope of the claims. An embodiment derived from a proper combination of technical means appropriately modified within the scope of the claims is also encompassed in the technical scope of the present invention.

Lastly, each block of the display device 1, in particular, the video processing circuit 2 and the backlight control circuit 3 can be configured by hardware logic, or realized by software with the use of a CPU as follows.

That is, the display device 1 includes a CPU (Central Processing Unit) and a storage device (storage medium) such as a ROM (Read Only Memory), a RAM (Random Access Memory), and a memory. The CPU executes instructions of control programs for realizing the functions. In the ROM, the programs are stored. Into the RAM, the programs are loaded. In the memory, the programs and various data are stored. The objective of the present invention can also be achieved, by (i) supplying a storage medium, in which program codes (executable programs, intermediate code programs, source programs) of programs for controlling the display device 1 configured by software for realizing the functions, are stored so that a computer can read them, to the display device 1, and then (ii) causing the computer (or CPU or MPU) to read and execute the program codes stored in the storage medium.

The storage medium can be, for example, a tape such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM (Registered Trademark), or flash ROM.

Alternatively, the display device 1 can be arranged to be connectable to a communications network so that the program codes are delivered over the communications network. The communications network is not limited to a specific one, and therefore can be, for example, the Internet, an intranet, extranet, LAN, ISDN, VAN, CATV communications network, virtual private network, telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR, mobile telephone network, satellite line, or terrestrial digital network. Note that, the present invention can be realized by a computer data signal (i) which is realized by electronic transmission of the program code and (ii) which is embedded in a carrier wave.

(Main Points)

As above described, the display device in accordance with an aspect of the present invention includes: a display section for displaying a video; and control means for aperiodically changing at least any of a brightness and a contrast of the video, which is displayed on the display section, within a predetermined range during predetermined time period.

According to the configuration, the display device can reproduce instability of a lamp (lamp fluctuation), i.e., a state in which light emitted by the lamp becomes bright and dark in an aperiodic manner similar to that of an actual projector.

That is, the display device can reproduce an atmosphere of watching a video of an old movie at an old movie theater.

According to the display device in accordance with an aspect of the present invention, it is preferable that the display section includes a backlight; and the control means includes backlight control means for aperiodically changing a brightness of the backlight within a predetermined range during a predetermined time period.

According to the configuration, the display device can aperiodically change the brightness of the backlight. This makes it possible, more properly, to reproduce aperiodic lamp fluctuation which is similar to that of an actual projector.

According to the display device in accordance with an aspect of the present invention, it is preferable that the control means includes contrast control means for aperiodically changing the contrast of the video within the predetermined range during the predetermined time period by correcting pixel values of the video.

According to the configuration, the display device can aperiodically change the contrast of the video. This makes it possible, more properly, to reproduce aperiodic lamp fluctuation which is similar to that of an actual projector.

According to the display device in accordance with an aspect of the present invention, it is preferable that the display device further includes random number table managing means for managing a random number table; and the control means aperiodically changes at least any of the brightness and the contrast of the video within the predetermined range during the predetermined time period with reference to the random number table.

This allows the display device, more properly, to reproduce aperiodic lamp fluctuation which is similar to that of an actual projector.

According to the display device in accordance with an aspect of the present invention, it is preferable that the control means aperiodically changes at least any of the brightness and the contrast of the video within the predetermined range during the predetermined time period with reference to moving averages of random numbers included in the random number table.

This allows the display device, more gently, to reproduce aperiodic lamp fluctuation which is similar to that of an actual projector.

According to the display device in accordance with an aspect of the present invention, it is possible that the predetermined range is determined in accordance with a size of the display section.

In a case where the size of the display section of the display device is large and the brightness and/or the contrast are greatly changed, some users may possibly feel ill.

According to the configuration, the predetermined range is determined in accordance with the size of the display section of the display device. This makes it possible, more properly, to reproduce aperiodic lamp fluctuation which is similar to that of an actual projector, without making the user uncomfortable.

According to the display device in accordance with an aspect of the present invention, it is preferable that the control means is configured to determine the predetermined range to be narrowed in stages as a setting value for setting a brightness of a screen, on which the video is displayed, is increased.

As above described, in a case where the brightness of the screen is excessively changed, the user may feel unnaturalness. In view of this, according to the configuration, the display device does not change the brightness of the screen so largely in a case where the user sets the screen to have a strong brightness.

Therefore, the display device can reduce unnaturalness felt by the user.

According to the display device in accordance with an aspect of the present invention, it is preferable that the control means is configured to determine a width of the predetermined range in accordance with any of combinations, each of which is a combination of the setting value and a screen size of the screen, with reference to predetermined data that indicates a width of the predetermined range for each of the combinations; the predetermined data shows that a screen size, which is combined with the setting value and to which a relatively narrow range is assigned, is larger than a screen size, which is combined with the setting value and to which a relatively wide range is assigned; and the predetermined data shows that a setting value, which is combined with a screen size and to which a relatively narrow range is assigned, is larger than a setting value, which is combined with the screen size and to which a relatively wide range is assigned.

As above described, in a case where the user sets the screen to have a strong brightness, the unnaturalness tends to become stronger as the screen size becomes larger. In view of this, according to the configuration, the display device determines the width of the variation range of the screen brightness in accordance with a combination of the setting value for setting brightness and the screen size. Specifically, in a case where the screen size is large, the display device sets the variation range of the screen brightness to be relatively narrow, and in a case where the screen size is small, the display device sets the variation range of the screen brightness to be relatively wide. Therefore, the display device can carry out, more appropriately, the process for reducing unnaturalness felt by the user in accordance with the screen size.

The controlling method in accordance with an aspect of the present invention is a method for controlling a display device having a display section for displaying a video, the method including the step of: aperiodically changing at least any of a brightness and a contrast of the video, which is displayed on the display section, within a predetermined range during a predetermined time period.

According to the configuration, it is possible to bring about an effect similar to that of the display device of the present invention.

Moreover, a television receiver including the display device is also encompassed in the scope of the present invention.

The present invention encompasses (i) a control program for operating the display device, which control program causes a computer to function as the means of the display device and (ii) a computer-readable storage medium which stores the control program.

### INDUSTRIAL APPLICABILITY

The display device of the present invention can be generally applied to a display device such as a television.

### REFERENCE SIGNS LIST

1: Display device
2: Video processing circuit (control means, contrast control means, random number table managing means)
3: Backlight control circuit (control means, backlight control means)
4: Driving circuit
5: Display panel
6: Backlight
7: Display section

1. A display device comprising:
a display section for displaying a video; and
a control section configured to change at least any of a brightness and a contrast of the video, which is displayed on the display section, within a predetermined range during a predetermined time period,
the control section being configured to determine the predetermined range to be narrowed in stages as a setting value for setting a brightness of a screen, on which the video is displayed, is increased.

2. The display device as set forth in claim 1, wherein:
the display section includes a backlight; and
the control section includes a backlight control section configured to change a brightness of the backlight within a predetermined range during a predetermined time period.

3. The display device as set forth in claim 1, wherein:
the control section includes a contrast control section configured to change the contrast of the video within the predetermined range during the predetermined time period by correcting pixel values of the video.

4. The display device as set forth in claim 1, further comprising:
a random number table managing section configured to manage a random number table;
the control section changing at least any of the brightness and the contrast of the video within the predetermined range during the predetermined time period with reference to the random number table.

5. The display device as set forth in claim 4, wherein:
the control section changes at least any of the brightness and the contrast of the video within the predetermined range during the predetermined time period with reference to moving averages of random numbers included in the random number table.

6. The display device as set forth in claim 1, wherein:
the predetermined range is determined in accordance with a size of the display section.

7. (canceled)

8. The display device as set forth in claim 1, wherein:
the control section is configured to determine a width of the predetermined range in accordance with any of combinations, each of which is a combination of the setting value and a screen size of the screen, with reference to predetermined data that indicates a width of the predetermined range for each of the combinations;
the predetermined data shows that a screen size, which is combined with the setting value and to which a relatively narrow range is assigned, is larger than a screen size, which is combined with the setting value and to which a relatively wide range is assigned; and
the predetermined data shows that a setting value, which is combined with a screen size and to which a relatively narrow range is assigned, is larger than a setting value, which is combined with the screen size and to which a relatively wide range is assigned.

9. A method for controlling a display device having a display section for displaying a video, said method comprising the step of:
changing at least any of a brightness and a contrast of the video, which is displayed on the display section, within a predetermined range during a predetermined time period,
in the step of changing at least any of a brightness and a contrast of the video, the predetermined range being determined to be narrowed in stages as a setting value for setting a brightness of a screen, on which the video is displayed, is increased.

10. A television receiver comprising a display device recited in claim 1.

11. (canceled)

12. A non-transitory computer-readable storage medium storing a control program for operating a computer as a display device recited in claim 1, the control program causing the computer to serve as the control section of the display device.
